(19) United States
(12) Patent Application Publication
(10) Pub. No.: US 2014/0058898 A1
(43) Pub. Date: Feb. 27, 2014

(54) Network Fuzzy Shopping Implementation Method and System

(71) Applicant: Wanchun Hou, Shandong (CN)

(72) Inventor: Wanchun Hou, Shandong (CN)

(21) Appl. No.: 14/114,216

(22) PCT Filed: Feb. 29, 2012
(86) PCT No.: PCT/CN2012/071750

§ 371 Date: Oct. 27, 2013

(30) Foreign Application Priority Data
Apr. 28, 2011 (CN) 201110108700.9

(51) Int. Cl. G06Q 30/06

(52) U.S. Cl. CPC G06Q 30/0631; G06Q 30/0623
USPC 705/26.61

(57) ABSTRACT

A network fuzzy shopping method includes the steps of a fuzzy shopping network server providing to a buyer a user interface including a fuzzy shopping selection or menu; collecting product features that a user wants to buy and transmitting product purchasing demand information about the buyer to the fuzzy shopping seller accounts of all the associated merchants selling the type of products that the products belong to; the fuzzy shopping seller receiving the product purchasing demand information and sending information regarding targeted products which meet the product demand features to the fuzzy shopping buyer account of the user, and the fuzzy shopping buyer receiving a part or all of the marked products and additional information provided by the fuzzy shopping seller accounts; and selecting a fuzzy shopping seller and targeted products and submitting a purchasing order within a validity period of fuzzy shopping.

### BACKGROUND OF THE PRESENT INVENTION

1. Field of Invention

The present invention relates Internet, and more particularly to a network fuzzy shopping implementation system and method thereof.

2. Description of Related Arts

With the advance of information technology, online or web-based shopping has provided users with an extremely convenient and effective way of shopping. Nowadays, there has been a growing trend to develop fuzzy shopping business model for internet users, especially for those who have access to internet while traveling (i.e. mobile interne users). Fuzzy shopping refers to a business model where a buyer describes his or her actual needs and the required specifications or information or a potential product over interne, while a seller tries to search for suitable products or make suggestions in response to the requirements and conditions given by the buyer. The seller will send, over interne, a list of suggested or recommended products for buyer's selection. The buyer will then make a corresponding decision based on the seller's recommendations.

Online shopping methods based on fuzzy shopping model have not been extensively developed. It is expected that when an internet based fuzzy shopping model is maturely developed, online shopping will become a very convenient and effective business model, in which users' demand will be effectively and optimally matched with suitable products in the right price range. However, there is currently not much research and development in the field of interne based fuzzy shopping business model.

Moreover, there has been no patent document relating to fuzzy shopping business model.

### SUMMARY OF THE PRESENT INVENTION

The invention is advantageous in that it provides a network fuzzy shopping implementation system and method in order to provide fuzzy shopping service to internet users.

According to the present invention, the foregoing and other objects and advantages are attained by providing an internet based fuzzy shopping system and method thereof.

The network fuzzy shopping method provided by one aspect of the present invention comprises the steps of:

(a) interactively connecting a user terminal with a fuzzy shopping network server through internet, wherein the fuzzy shopping network server is arranged to provide a fuzzy shopping platform, and a user (buyer) operating the user terminal is able to log in to the fuzzy shopping platform by using a user account information;

(b) generating a fuzzy shopping user interface, which can be an interactive webpage, on the user terminal by the fuzzy shopping network server, wherein the fuzzy shopping user interface provides a plurality of shopping selections (such as buttons) and menus for the user;

(c) sending a product purchasing demand, such as a product request, with a targeted product from the user terminal to the fuzzy shopping network server, wherein the product purchasing demand contains a potential product feature, such that the fuzzy shopping network server collects the product purchasing demand that the user wants to buy;

(d) transmitting the product purchasing demand from the user terminal to at least one seller, wherein each of the sellers is arranged to register a seller account as an associated merchant in the fuzzy shopping network server;

(e) in response to the product purchasing demand, generating product information by the corresponding seller, and sending the product information to the user terminal through the fuzzy shopping network server, wherein the product information corresponds to the potential product feature of the product purchasing demand, such that the buyer receives a part or all of the targeted products and additional information provided by the fuzzy shopping seller accounts; and

(f) reviewing the product information by the user on the user terminal from one or more corresponding sellers, and selectively sending at least one purchase order to the fuzzy shopping network server through the user terminal, such that the buyer is able to select one of the fuzzy shopping sellers and marked products and submits a purchasing order within a validity period of fuzzy shopping.

In step (a), the user may log on the fuzzy shopping platform and leave the product purchasing demand to the fuzzy shopping platform. The potential product feature may include the type, features and performance, and the desired price range of the potential product. It is worth mentioning that at this stage, the user may not have a particular product in his or her mind. Rather, the user is merely sending the requirements of his or her desired product and sees if the registered seller of the fuzzy shopping platform may be able to provide him/her any suitable product.

Step (a) further comprises a step of verifying an identity of the user so that only the registered user may be able to use the fuzzy shopping platform generated by the fuzzy shopping network server.

In step (c), the potential product feature contains information about the nature of the potential product, the functions of the potential product, and a description of the potential product.

In step (e), each of the sellers has to register with the fuzzy shopping platform through the fuzzy shopping network server, wherein the seller may be able to log on to the fuzzy shopping platform through a predetermined seller account. When the seller log on to the fuzzy shopping platform, the seller may receive the product purchasing demand sent by the registered user of the fuzzy shopping platform.

In step (f), when the fuzzy shopping network server has received the list of products information from the registered seller, the fuzzy shopping network server is arranged to display it on the fuzzy shopping user interface when the registered user of the fuzzy shopping platform logs on thereto.

Moreover, the present invention provides a network fuzzy shopping system, comprising:

at least one access gateway;

at least one user terminal electrically connected to the access gateway so as to connect to internet through the access gateway; and

at least one fuzzy shopping network server electrically connected to the internet through the access gateway, wherein the fuzzy shopping network server and the user terminal is communicated with each other through the internet, wherein the fuzzy shopping network server is arranged to provide a fuzzy shopping platform containing a fuzzy shopping user interface for allowing a user to register and log in to the fuzzy shopping platform by using a user account information, wherein the fuzzy shopping user interface provides a plurality of shopping selections and menus for the user for sending at least one product purchasing demand from the user terminal to the fuzzy shopping network server, wherein the product purchasing demand contains a potential product feature, wherein the product purchasing demand is arranged to be reviewed by a registered seller who, in response to the product purchasing demand, is arranged to generate product information, wherein the product information corresponds to the potential product feature of the product purchasing demand for allowing the user to review the product information on the user terminal, and selectively send at least one purchase order to the fuzzy shopping network server through the user terminal for purchase of suitable products. Thus, the fuzzy shopping system is arranged to establish a fuzzy shopping platform for accomplishing a business transaction of suitable and selected products.

The business transaction refers to selection of products, paying for the products and shipping of the products through the fuzzy shopping system.

The advantageous effect of the present invention is that when a buyer cannot decide what he or she is going to purchase, the fuzzy shopping system and method of the present invention may provide the user (i.e. the buyer) of the present invention with a wide variety of selections, wherein the relevant products are suited to the request or needed of the buyer so that the entire online purchase procedure will become very efficient and effective. Moreover, the buyer may be able to select the least-expensive item so that the fuzzy shopping system of the present invention is capable of helping the buyer from getting the most suitable and economical deals.

### BRIEF DESCRIPTION OF THE DRAWINGS

FIG. 1 is a schematic diagram of a fuzzy shopping system according to a preferred embodiment of the present invention.

FIG. 2 is another schematic diagram of a fuzzy shopping system according to the above preferred embodiment of the present invention.

### DETAILED DESCRIPTION OF THE PREFERRED EMBODIMENT

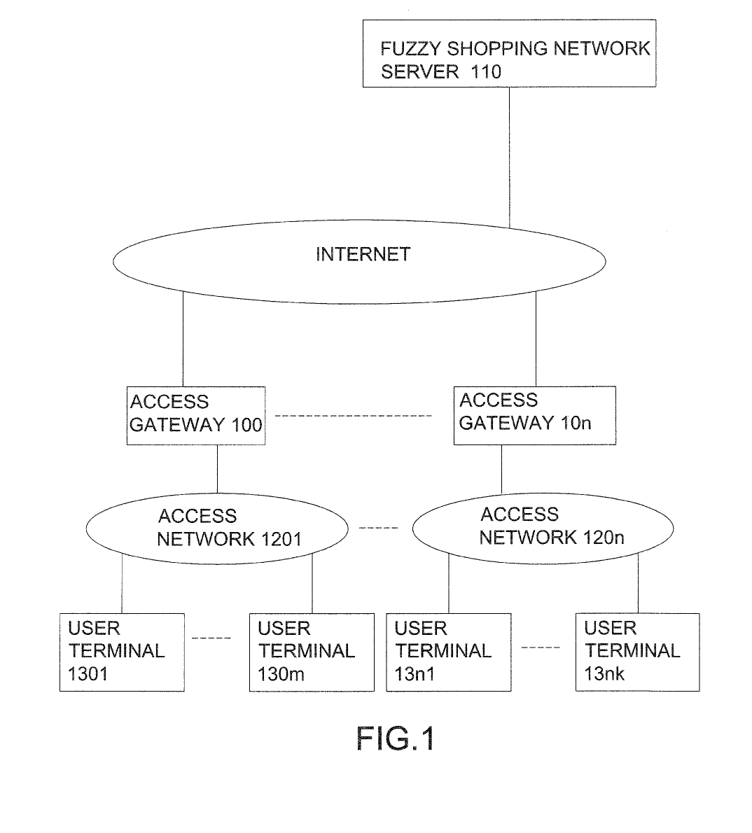

Referring to FIG. 1 of the drawings, a network fuzzy shopping system according to a preferred embodiment of the present invention is illustrated, in which the internet-based fuzzy shopping system comprises a plurality of user terminals electrically linked to internet, and a fuzzy shopping network server also electrically linked to internet and communicated to the user terminals through the internet.

The user terminals 1300 are designated in FIGS. 1 as 1301 to 130m and 13n1 to 13nk. Each of the user terminals 1300 is connected and linked to a predetermined access network 1200 (designated in FIGS. 1 as 1201 to 120n for each of the user terminals 1300). Moreover, each of the access networks is communicated to the internet through a corresponding access gateway 100 (designated in FIGS. 1 as 100 to 10n).

It is worth mentioning that the connection between the user terminals 130m or any other user terminals 1300 and the access network 1200 can be through wired connection or wireless connection. The relevant access network 1200 is then connected to the internet through the corresponding access gateway 100.

Similarly, the connection between the user terminals 130n0 (i.e. user terminal 13n1-13nk) and the access network 120n can also be through wired connection or wireless connection. The relevant access network 120n is then connected to the internet through the corresponding access gateway 10n.

The connection between the user terminals 130nk and the access network 120n can also be through wired connection or wireless connection. The relevant access network 120n is then connected to the internet through the corresponding access gateway 10n.

The fuzzy shopping network server 110 is connected to the internet, and is eventually communicated with at least one of the user terminals 1300 of the internet based fuzzy shopping system.

The present invention also provides an internet based fuzzy shopping method, comprising the steps of:

(a) interactively connecting a user terminal 1300 with a fuzzy shopping network server 110 through internet, wherein the fuzzy shopping network server 110 is arranged to provide a fuzzy shopping platform, and a user (buyer) operating the user terminal 1300 is able to log in to the fuzzy shopping platform by using a user account information;

(b) generating a fuzzy shopping user interface, which can be an interactive webpage, on the user terminal 1300 by the fuzzy shopping network server 110, wherein the fuzzy shopping user interface provides a plurality of shopping selections (such as buttons) and menus for the user;

(c) sending a product purchasing demand, such as a product request, with a targeted product from the user terminal 1300 to the fuzzy shopping network server 110, wherein the product purchasing demand contains a potential product feature, such that the fuzzy shopping network server 110 collects the product purchasing demand that the user wants to buy;

(d) transmitting product purchasing demand from the user terminal 1300 to at least one seller, wherein each of the sellers is arranged to register a seller account as an associated merchant in the fuzzy shopping network server 110;

(e) in response to the product purchasing demand, generating product information by the corresponding seller, and sending the product information to the user terminal 1300 through the fuzzy shopping network server 110, wherein the product information corresponds to the potential product feature of the product purchasing demand, such that the buyer receives a part or all of the targeted products and additional information provided by the fuzzy shopping seller accounts; and

(f) reviewing the product information by the user on the user terminal 1300 from one or more corresponding sellers, and selectively sending at least one purchase order to the fuzzy shopping network server 110 through the user terminal 1300, such that the buyer is able to select one of the fuzzy shopping sellers and marked products and submits a purchasing order within a validity period of fuzzy shopping.

In step (a), the user may log on the fuzzy shopping platform and leave the product purchasing demand to the fuzzy shopping platform. The potential product feature may include the type, features and performance, and the desired price range of the potential product. It is worth mentioning that at this stage, the user may not have a particular product in his or her mind. Rather, the user is merely sending the requirements of his or her desired product and sees if the registered seller of the fuzzy shopping platform may be able to provide him/her any suitable product.

Step (a) further comprises a step of verifying an identity of the user so that only the registered user may be able to use the fuzzy shopping platform generated by the fuzzy shopping network server 110.

In step (c), the potential product feature contains information about the nature of the potential product, the functions of the potential product, and a description of the potential product.

In step (e), each of the sellers has to register with the fuzzy shopping platform through the fuzzy shopping network server 110, wherein the seller may be able to log on to the fuzzy shopping platform through a predetermined seller account. When the seller log on to the fuzzy shopping platform, the seller may receive the product purchasing demand sent by the registered user of the fuzzy shopping platform.

In step (f), when the fuzzy shopping network server 110 has received the list of products information from the registered seller, the fuzzy shopping network server 110 is arranged to display it on the fuzzy shopping user interface when the registered user of the fuzzy shopping platform logs on thereto.

Thus, the present invention also provides a internet based fuzzy shopping system, which comprises:

at least one access gateway;

at least one user terminal 1300 electrically connected to the access gateway 100 so as to connect to internet through the access gateway 100; and

at least one fuzzy shopping network server 110 electrically connected to the internet through the access gateway 100, wherein the fuzzy shopping network server 110 and the user terminal 1300 is communicated with each other through the internet, wherein the fuzzy shopping network server is arranged to provide a fuzzy shopping platform containing a fuzzy shopping user interface for allowing a user to register and log in to the fuzzy shopping platform by using a predetermined account information, wherein the fuzzy shopping user interface provides a plurality of shopping selections and menus for the user for sending at least one product purchasing demand from the user terminal to the fuzzy shopping network server, wherein the product purchasing demand contains a potential product feature, wherein the product purchasing demand is arranged to be reviewed by a registered seller who, in response to the product purchasing demand, is arranged to generate product information, wherein the product information corresponds to the potential product feature of the product purchasing demand for allowing the user to review the product information on the user terminal 1300, and selectively send at least one purchase order to the fuzzy shopping network server 110 through the user terminal 1300 for purchase of suitable products.

The business transaction refers to selection of products, paying for the products and shipping of the products through the fuzzy shopping system.

The preferred embodiment of the internet based fuzzy shopping system and method thereof will be further elaborated below.

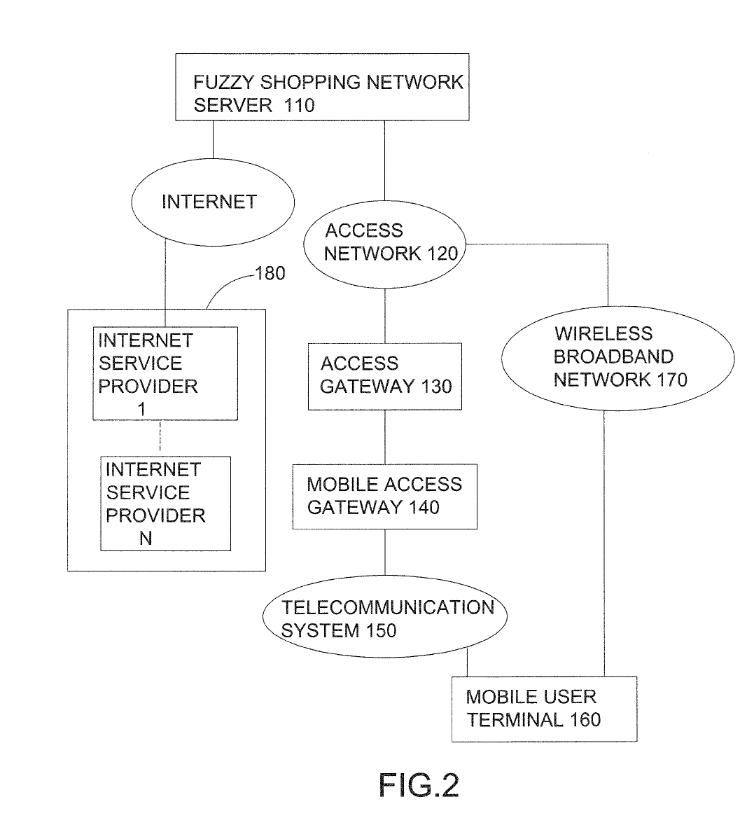

FIG. 2 illustrates a schematic diagram of the internet based fuzzy shopping system according to the preferred embodiment of the present invention.

The connection between the fuzzy shopping network server 110 and the corresponding access gateway 130 is accomplished by a predetermined IP data network by using TCP/IP socket, wherein the information exchanged between the fuzzy shopping network server 110 and the access gateway 130 may be encrypted or through a predetermined data format.

Furthermore, the fuzzy shopping network server 110 may also be wirelessly connected to a mobile user terminal 160. The connection between the fuzzy shopping network server 110 and the mobile user terminal 160 can be accompanied through a wireless broadband network 170, or through connecting to the access gateway 130 by a predetermined IP data network by using TCP/IP socket, wherein the information exchanged between the fuzzy shopping network server 110 and the access gateway 130 may be encrypted or through a predetermined data format.

On the other hand, the fuzzy shopping network server 110 may be connected to the internet through at least one internet service provider 180, wherein the connection between the fuzzy shopping network server 110 and the internet service provider 180 can be accomplished through a predetermined IP data network by using TCP/IP socket, wherein the information exchanged between the fuzzy shopping network server 110 and the internet service provider 180 may be encrypted or through a predetermined data format.

Each of the internet service providers 180 may comprise at least one internet server computer for providing internet service to the fuzzy shopping network server 110.

On the other hand, the connection between the access gateway 130 and the mobile access gateway 140 is through a predetermined data network, wherein information is transferred in the data network by using TCP/IP socket, and may be encrypted or through a predetermined data format.

Moreover, the information transmitted to and from the mobile access gateway 140 is through a telecommunication system 150 and transmitted under a predetermined protocol.

The information transmitted to and from the mobile user terminal 160 through the telecommunication system 150 is under a predetermined transfer protocol.

The telecommunication system 150 comprises one of a radio network subsystem (RNS) and a base station subsystem (BSS) for use in a telecommunication network.

In this preferred embodiment, the present invention provides a fuzzy shopping method, which comprises the steps of:

(a) connecting a mobile user terminal 160 with a fuzzy shopping network server 110 through interne and a telecommunication network, wherein the fuzzy shopping network server 110 is arranged to provide a fuzzy shopping platform, and a user operating the mobile user terminal 160 is able to log in to the fuzzy shopping platform by using a user account information;

(b) generating a fuzzy shopping user interface on the mobile user terminal 160 by the fuzzy shopping network server 110, wherein the fuzzy shopping user interface provides a plurality of shopping selections (such as buttons) and menus for the user;

(c) sending a product purchasing demand from the mobile user terminal 160 to the fuzzy shopping network server 110, wherein the product purchasing demand contains a potential product feature, such as price request, such that the fuzzy shopping network server 110 collects the product purchasing demand that the user wants to buy;

(d) transmitting the product purchasing demand from the mobile user terminal 160 to at least one seller, wherein each of the sellers is arranged to register a seller account as an associated merchant in the fuzzy shopping network server 110;

(e) in response to the product purchasing demand, generating product information by the corresponding seller, and sending the product information to the mobile user terminal 160 through the fuzzy shopping network server 110, wherein the product information corresponds to the potential product feature of the product purchasing demand, such that the buyer receives a part or all of the targeted products and additional information provided by the fuzzy shopping seller accounts;

(f) reviewing the product information by the user on the mobile user terminal 160, and selectively sending at least one purchase order to the fuzzy shopping network server 110 through the mobile user terminal 160, such that the buyer is able to select one of the fuzzy shopping sellers and marked products and submits a purchasing order within a validity period of fuzzy shopping; and

(g) generating a payment request on the fuzzy shopping user interface by the fuzzy shopping network server 110, and sending a transaction record to the corresponding seller and the corresponding user when the corresponding transaction is completed.

One skilled in the art will understand that the embodiment of the present invention as shown in the drawings and described above is exemplary only and not intended to be limiting.

What is claimed is:

1. A network fuzzy shopping method, comprising the steps of:
(a) interactively connecting a user terminal with a fuzzy shopping network server through internet, wherein said fuzzy shopping network server is arranged to provide a fuzzy shopping platform, and a user operating said user terminal is able to log in to said fuzzy shopping platform by using a user account information;
(b) generating a fuzzy shopping user interface on said user terminal by said fuzzy shopping network server, wherein said fuzzy shopping user interface provides a plurality of shopping selections and menus for said user;
(c) sending a product purchasing demand from said user terminal to said fuzzy shopping network server, wherein said product purchasing demand contains a potential product feature;
(d) sending said product purchasing demand from said user terminal to at least one seller, wherein each of said sellers is arranged to register a seller account in said fuzzy shopping network server;
(e) in response to said product purchasing demand, generating product information by said corresponding seller, and sending said product information to said user terminal through said fuzzy shopping network server, wherein said product information corresponds to said potential product feature of said product purchasing demand; and
(f) reviewing said product information by said user on said user terminal, and selectively sending at least one purchase order to said fuzzy shopping network server through said user terminal.

2. The method as recited in claim 1 wherein, in said step (a), said user is arranged to log on said fuzzy shopping platform and leave said product purchasing demand to said fuzzy shopping platform.

3. The method, as recited in claim 1, wherein said step (a) further comprises a step of verifying an identity of said user so that only registered user is able to use said fuzzy shopping platform generated by said fuzzy shopping network server.

4. The method as recited in claim 1 wherein, in said step (c), wherein said potential product feature includes at least one of a type, a feature, a performance, and a desired price range of said potential product.

5. The method as recited in claim 1 wherein, in said step (e), said seller is arranged to register with said fuzzy shopping platform through said fuzzy shopping network server, wherein said seller is able to log on to said fuzzy shopping platform through a predetermined seller account, wherein when said seller logs on to said fuzzy shopping platform, said seller is arranged to receive said product purchasing demand sent by said registered user of said fuzzy shopping platform.

6. The method as recited in claim 1 wherein, in said step (f), when said fuzzy shopping network server receives said list of products information from said registered seller, said fuzzy shopping network server is arranged to display it on said fuzzy shopping user interface when said registered user of said fuzzy shopping platform logs on thereto.

7. A network fuzzy shopping system, comprising:
at least one access gateway;
at least one user terminal electrically connected to said access gateway so as to connect to internet through said access gateway; and
at least one fuzzy shopping network server electrically connected to said internet through said access gateway, wherein said fuzzy shopping network server and said user terminal is communicated with each other through said internet, wherein said fuzzy shopping network server is arranged to provide a fuzzy shopping platform containing a fuzzy shopping user interface for allowing a user to register and log in to said fuzzy shopping platform by using a predetermined account information, wherein said fuzzy shopping user interface provides a plurality of shopping selections and menus for said user for sending at least one product purchasing demand from said user terminal to said fuzzy shopping network server, wherein said product purchasing demand contains a potential product feature, wherein said product purchasing demand is arranged to be reviewed by a registered seller who, in response to said product purchasing demand, is arranged to generate product information, wherein said product information corresponds to said potential product feature of said product purchasing demand for allowing said user to review said product information on said user terminal, and selectively send at least one purchase order to said fuzzy shopping network server through said user terminal for purchase of suitable products, so that said fuzzy shopping system is capable of facilitating at least one business transaction between said user and said seller.

8. The fuzzy shopping system, as recited in claim 7, wherein said business transaction refers to selection of products, paying for the products and shipping of the products through the fuzzy shopping system.
